(19) United States
(12) Patent Application Publication
(10) Pub. No.: US 2021/0321757 A1
(43) Pub. Date: Oct. 21, 2021

(54) Grooming Tool with Storage Compartment

(71) Applicant: Jessica Ashley Oliver, Scarborough (CA)

(72) Inventor: Jessica Ashley Oliver, Scarborough (CA)

(21) Appl. No.: 16/850,175

(22) Filed: Apr. 16, 2020

(51) Int. Cl. A46B 15/00; A46B 5/00; A61H 19/00

(52) U.S. Cl. CPC A46B 15/0061; A46B 2200/104; A61H 19/40; A46B 5/0095

(57) ABSTRACT

A grooming tool; the grooming tool includes a grooming tool body having a handle and a grooming tool head. The handle includes a hidden compartment for discretely storing items therein. The grooming tool head may be a plurality of grooming tool heads that are interchangeable. The plurality of grooming tool heads includes a hairbrush.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of grooming tools of existing art and more specifically relates to hair grooming tools including storage compartments.

### RELATED ART

Hairbrushes and combs are grooming tools used in hair care for smoothing, styling, and detangling human hair. Conventional hairbrushes are formed as an elongated member typically including a handle portion and a head portion. Conventional combs generally consist of a shaft that holds a row of teeth. There are various types of hairbrushes and combs known in the art, and each type of hairbrush or comb has a different purpose or provides a different use. However, the hairbrushes and combs known in the art typically consist of one hairbrush/comb head per handle, meaning that individuals need multiple different hairbrushes and combs to achieve their desired look. Thus, there is a need for an all-in-one grooming tool providing all types of hairbrushes/combs in one.

A sex toy is an object, usually phallic in shape, that is primarily used to facilitate human sexual pleasure, such as a dildo or vibrator. Generally, sex toys are private items, often thought of as taboo and even illegal in some parts of the world. As such, individuals who own sex toys are often very secretive about them and keep them hidden away.

Due to the world-wide and consistent use of hairbrushes/combs, they do not draw attention. Thus, there is a need for a hairbrush or comb with a storage compartment that can discretely store or hide objects therein.

### SUMMARY OF THE INVENTION

In view of the foregoing disadvantages inherent in the known grooming tools art, the present disclosure provides a novel grooming tool with a storage compartment. The general purpose of the present disclosure, which will be described subsequently in greater detail, is to provide a grooming tool, particularly a hairbrush, with a plurality of detachable heads and at least one storage compartment. The detachable heads may each include a different type of brush or comb, such as a round brush, a paddle brush, a wide tooth comb, etc. The at least one storage compartment may discretely store an object, such as a sex toy, therein.

A grooming tool is disclosed herein. The grooming tool includes a grooming tool body and at least one grooming tool head. The grooming tool body may include a handle having a first handle-end, a second handle-end, and a hidden compartment therebetween. The hidden compartment may be configured to discretely house an object. The at least one grooming tool head may be removably connected to the handle via an attachment means and may be selectively detachable from the handle via the attachment means. Further, the at least one grooming tool head may include a first head-end and a second head-end.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a grooming tool with storage compartment, constructed and operative according to the teachings of the present disclosure.

FIG. 1 is a side top view of the grooming tool during an ‘in-use’ condition, according to an embodiment of the disclosure.

FIG. 2 is a side top view of the grooming tool of FIG. 1, according to an embodiment of the present disclosure.

FIG. 3A is a top view of the grooming tool of FIG. 1, according to an embodiment of the present disclosure.

FIG. 3B is a top view of the grooming tool of FIG. 1, according to an embodiment of the present disclosure.

FIG. 4A is a side top view of the grooming tool of FIG. 1, according to an embodiment of the present disclosure.

FIG. 4B is a front view of the grooming tool of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to grooming tools and more particularly to a grooming tool with a storage compartment as used to improve multi-purpose use of grooming tools, particularly hair grooming tools and provide a grooming tool with detachable heads and at least one storage compartment.

Generally disclosed is a hairbrush/comb device including a handle and a plurality of detachable heads that can easily be removed from the handle, and re-attached or interchanged. The plurality of detachable heads may each attach to the handle via a connector. The connector may include a pressure clip or threads for enabling each of the plurality of detachable heads to screw on or screw off the handle. This may allow a user to utilize different types of brushes and combs using the same handle.

The hairbrush/comb device may further include a hidden compartment within the handle of the hairbrush/comb device that may be used to store pleasure items, such as a sex toy, therein. Other items may be stored. The hairbrush/comb device may be open at a bottom thereof to allow access into the hidden compartment. The sex toy may be included with the hairbrush/comb device and configured for insertion into the hidden compartment, and for sealing the bottom of the hairbrush/comb device when the sex toy is stored within the hidden compartment.

One end of the sex toy may include threads thereon. The threads may be configured to mate with threads on the bottom of the hairbrush/comb device to secure the sex toy within the hidden compartment. Further, the threads on the sex toy may be configured to attach the sex toy to the handle, placing the sex toy in a ready-for-use position, essentially extending a length of the sex toy and providing an improved grip on the sex toy.

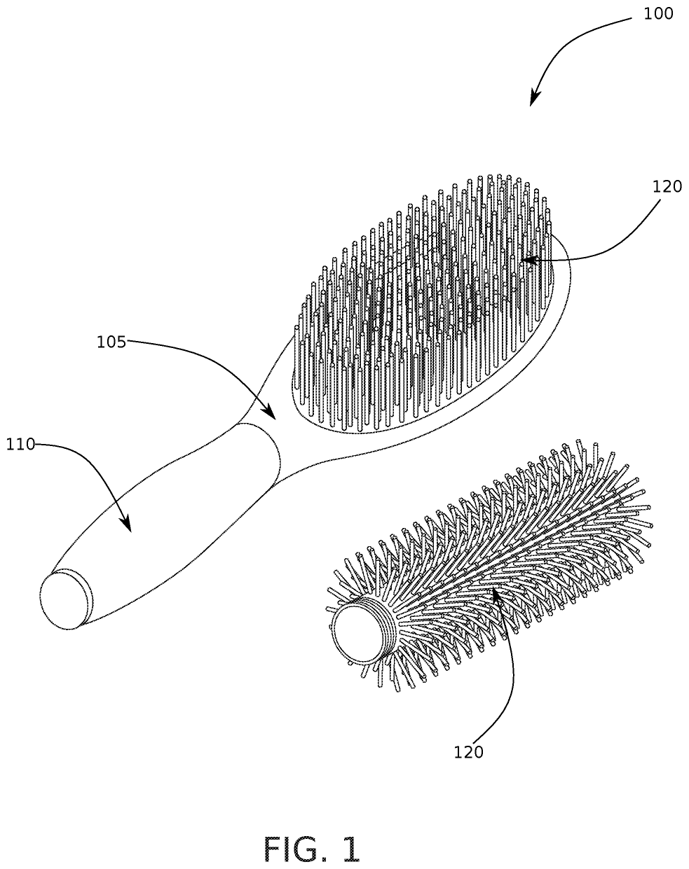

Referring now more specifically to the drawings by numerals of reference, there is shown in FIGS. 1-4B, various views of a grooming tool 100.

FIG. 1 shows a grooming tool 100 according to an embodiment of the present disclosure. The grooming tool 100 may be beneficial for use by a user to discretely store a sex toy. The grooming tool 100 may also allow for grooming use, thus being multi-purpose in design. As illustrated, the grooming tool 100 may include a grooming tool body 105 comprising a handle 110 and at least one grooming tool head 120. Preferably, as shown, the grooming tool 100 may be a hair grooming tool, such as a hairbrush or a comb, and may include more than one grooming tool head 120 to allow the user to interchange and utilize different grooming tool types (shown here to be two different types of hairbrush).

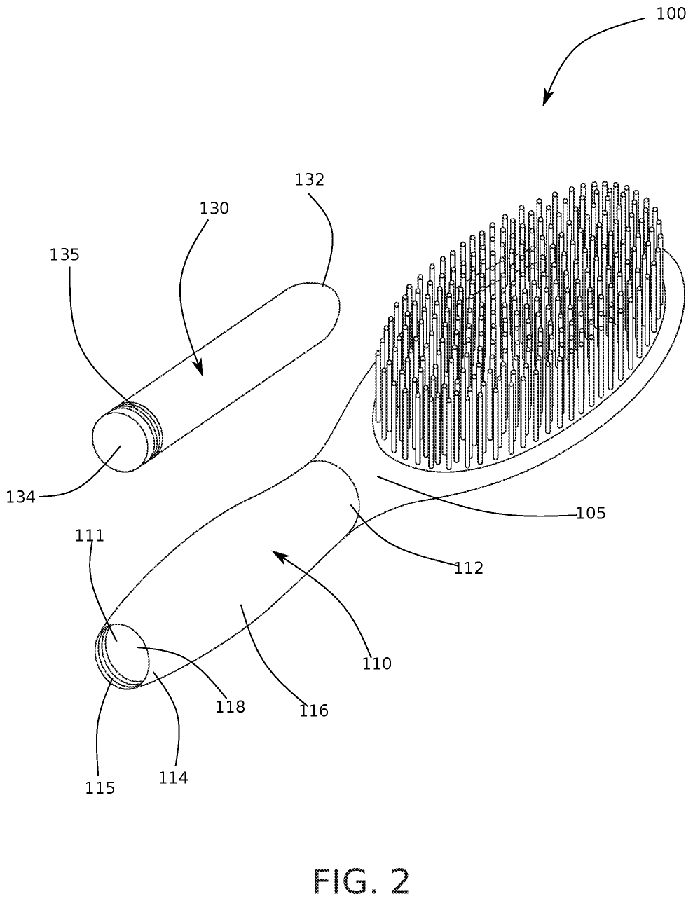

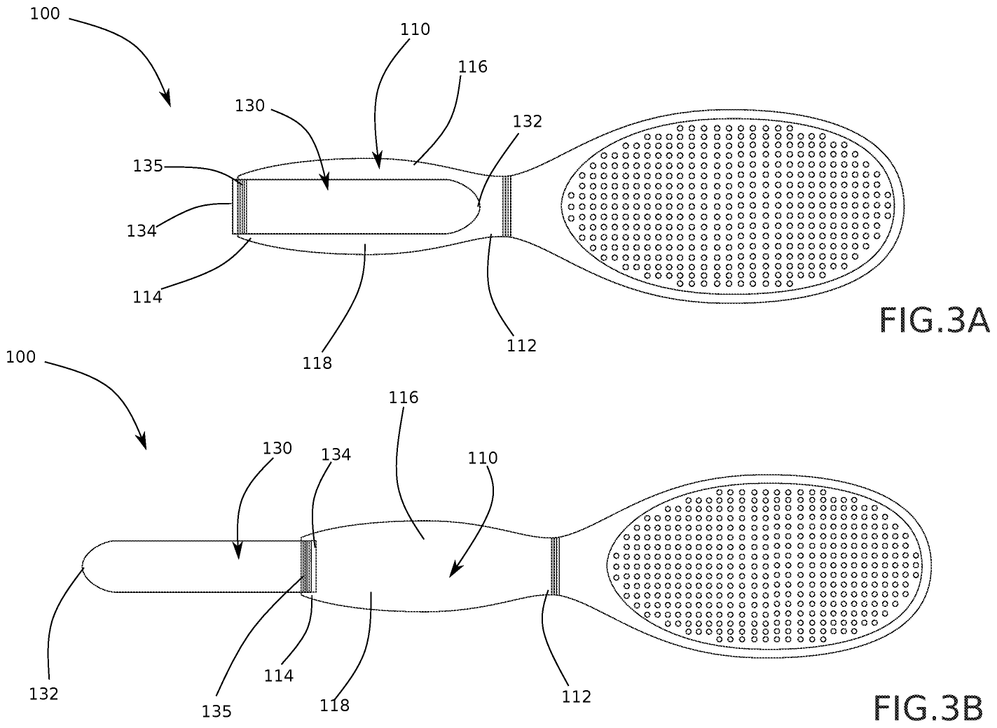

Referring now to FIGS. 2-3B showing various views of the grooming tool 100 of FIG. 1, according to an embodiment of the present disclosure. The handle 110 may include a first handle-end 112, a second handle-end 114, and a handle-body 116 therebetween. As shown, the second handle-end 114 may be substantially open and define an opening 111. The second handle-end may include a first handle-thread 115. As shown, the first handle-thread 115 may be a female thread and disposed within an inner surface of the second handle-end 114.

The handle-body 116 may include a hidden compartment 118 therein and the opening 111 may provide access to the hidden compartment 118. The hidden compartment 118 may be configured to discretely house an object. In a preferred embodiment, the object may be a sex toy 130. The handle-body 116 may include a shape that accommodates a size and shape of the sex toy 130. Preferably, the sex toy 130 may be included with the grooming tool 110. In this embodiment, the sex toy 130 may include a first toy-end 132 and a second toy-end 134. The second toy-end 134 may include a toy-thread 135 thereon. The sex toy 130 may be configured for insertion (first toy-end 132 first) into the hidden compartment 118 via the opening 111 of the second handle-end 114 and configured to seal the opening 111 of the second handle-end 114 when the sex toy 130 is housed within the hidden compartment 118. As shown in FIG. 3A, the second toy-end 134 may protrude from the second handle-end 114 when the sex toy 130 is housed within the hidden compartment 118. This may allow the user to grasp the second toy-end 134 and permit easy removal of the sex toy 130 from the hidden compartment 118.

The second toy-end 134 may include a toy-thread 135. As shown, the toy-thread 135 may be a male thread. The toy-thread 135 may be configured to mate with the first handle-thread 115 to selectively remove and replace the sex toy 130 within the hidden compartment 118 (FIG. 3A). Further, the toy-thread 135 may be configured to mate with the first handle-thread 115 to attach the sex toy 130 to the second handle-end 114 and place the sex toy 130 in a ready-for-use position (FIG. 3B).

In use, the user may unscrew the sex toy 130 from the second handle-end 114 and pull the sex toy 130 from the hidden compartment 118. The user may then turn the sex toy 130 around and screw the sex toy 130 onto the second handle-end 114, mating the toy-thread 135 of the second toy-end 134 with the first handle-thread 115 of the second handle-end 114 so that the first toy-end 132 is facing away from the grooming tool body 105, effectively lengthening the sex toy 130. This ready-for-use position may allow the user to grasp the handle-body 116 of the handle 110 whilst using the sex toy 130.

In other embodiments, the sex toy 130 may be separate from the grooming tool 100 such that the user may store an already purchased sex toy 130 in the hidden compartment 118. Further, in some embodiments, the object may not be a sex toy 130.

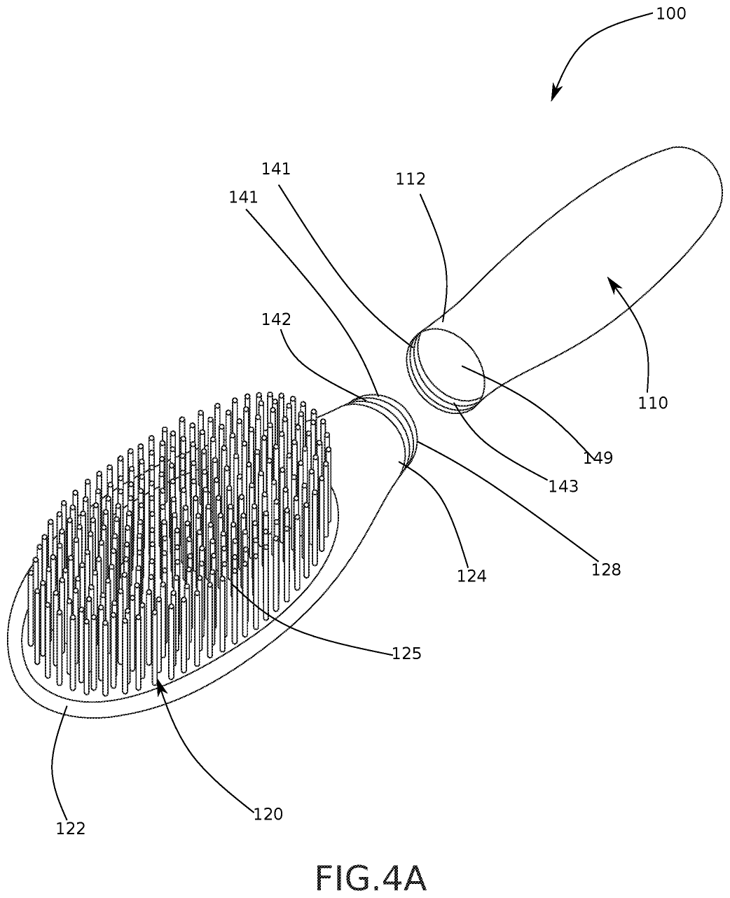

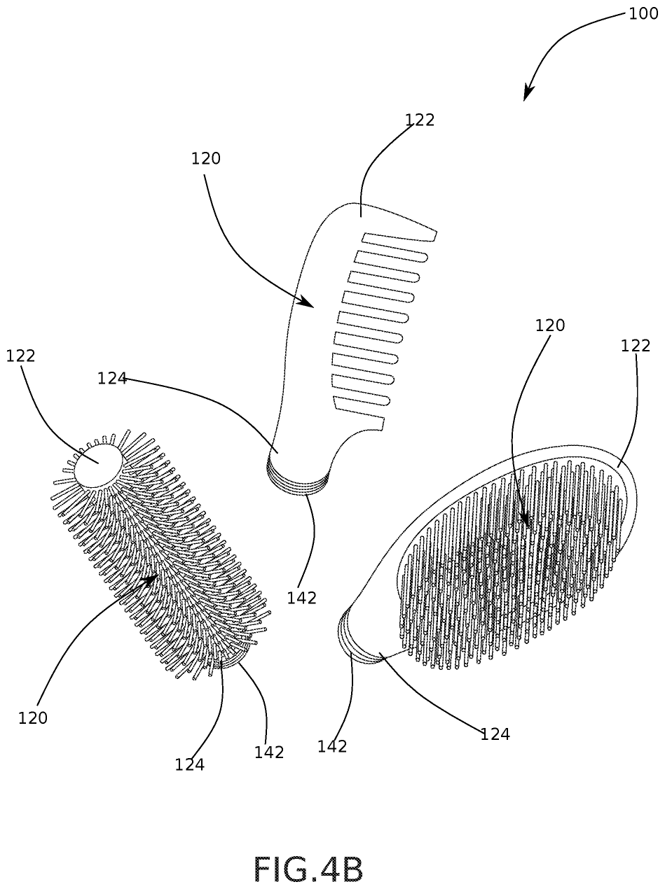

Referring now to FIGS. 4A-4B showing various views of the grooming tool 100 of FIG. 1, according to an embodiment of the present disclosure. The at least one grooming tool head 120 may include a first head-end 122 and a second head-end 124. In one embodiment, the at least one grooming tool head 120 may include at least two grooming tool heads 120. As above, the grooming tool 100 is preferably the hair grooming tool and as such, at least one of the at least two grooming tool heads 120 may include a hairbrush 125.

Preferably, the at least one grooming tool head 120 may include a plurality of grooming tool heads 120. The plurality of grooming tool heads 120 may include different types of hairbrushes such as detangling brushes, round brushes, paddle brushes, boar bristle brushes, shine enhancing brushes, smoothing brushes, and the like. The plurality of grooming tool heads may further include different types of combs such as wide tooth combs, fine-tooth combs, teasing combs, and the like.

It should be appreciated that the plurality of grooming tool heads 120 are not limited to hairbrushes and combs. Other types of grooming tool heads, particularly hair grooming tool heads may include hair straighteners (including hair straightening brushes having heating means), hair curling irons, hair crimping irons, hair dryers, hair clippers, and the like.

Further, it should also be appreciated that the plurality of grooming tool heads 120 are not limited to just hair grooming tools. In addition, the examples listed above are not exhaustive and as such, the other types of grooming tools not listed above are contemplated to be included in the plurality of grooming tool heads 120.

The at least one grooming tool head 120 may be removably connected to the handle 110 via an attachment means 141 and selectively detachable from the handle 110 via the attachment means 141. In one embodiment and as shown, the attachment means 141 may include the second head-end 124 including a first head-thread 142; and the first handle-end 112 including a second handle-thread 143 configured to mate with the first head-thread 142. In one embodiment and as illustrated, the first head-thread 142 may be a male thread and the second handle-thread 143 may be a female thread. In this embodiment, the second head-end 124 may be include a head attachment-portion 128 having the first head-thread 142 thereon, and the first handle-end 112 may be substantially open, defining a second opening 149 and having the second handle-thread 143 therein.

In another embodiment, the first head-thread 142 may be a female thread and the second handle-thread 143 may be a male thread (not illustrated). In this embodiment, the second head-end 124 may include a head-opening having the first head-thread 142 therein, and the first handle-end 112 may include a handle attachment-portion with the second handle-thread 143 thereon (the handle attachment-portion being configured for insertion into the aperture of the second head-end 124). In use, the user may unscrew a grooming tool head from the handle 110 to remove the grooming tool head, choose a different grooming tool head to use, and screw the different grooming tool head onto the handle 110.

In other embodiments, the attachment means 141 may include a clip (not illustrated). In one embodiment, the clip may include a spring. In another embodiment, the clip may include a release button which may be pressed to unlatch the clip. In another embodiment, the clip may include side release means. The second head-end 124 of the at least one grooming tool head 120 may include arms configured for mating with apertures located in the first handle-end 112 of the handle 110. When the at least one grooming tool head 120 is attached to the handle 110, the arms may protrude from apertures, locking the at least one grooming tool head 120 to the handle 110.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A grooming tool comprising:
a grooming tool body including:
a handle having a first handle-end, a second handle-end, and a handle-body therebetween, the handle-body including a hidden compartment therein, the hidden compartment configured to discretely house an object; and
at least one grooming tool head removably connected to the handle via an attachment means, the at least one grooming tool head including a first head-end and a second head-end, the at least one grooming tool head being selectively detachable from the handle via the attachment means.

2. The grooming tool of claim 1, wherein the object is a sex toy, and wherein the sex toy includes a first toy-end and a second toy-end.

3. The grooming tool of claim 1, wherein the second handle-end is substantially open and defines an opening.

4. The grooming tool of claim 3, wherein the second handle-end includes a first handle-thread.

5. The grooming tool of claim 4, wherein the sex toy is configured for insertion into the hidden compartment via the opening of the second handle-end and configured to seal the opening of the second handle-end when the sex toy is housed within the hidden compartment.

6. The grooming tool of claim 5, wherein the second toy-end of the sex toy includes a toy-thread.

7. The grooming tool of claim 6, wherein the toy-thread is configured to mate with the first handle-thread to selectively remove and replace the sex toy within the hidden compartment.

8. The grooming tool of claim 7, wherein the toy-thread is configured to mate with the first handle-thread to attach the sex toy to the second handle-end and place the sex toy in a ready-for-use position.

9. The grooming tool of claim 1, wherein the attachment means includes the second head-end including a first head-thread, and the first handle-end including a second handle-thread configured to mate with the first head-thread.

10. The grooming tool of claim 1, wherein the at least one grooming tool head includes at least two grooming tool heads, and wherein at least one of the at least two grooming tool heads includes a hairbrush.

11. A grooming tool assembly comprising:
a sex toy; and
a grooming tool, the grooming tool including:
a grooming tool body having:
a handle having a first handle-end, a second handle-end, and a handle-body therebetween, the handle-body including a hidden compartment therein, the hidden compartment configured to discretely house the sex toy; and
at least one grooming tool head removably connected to the handle via an attachment means, the at least one grooming tool head including a first head-end and a second head-end, the at least one grooming tool head being selectively detachable from the handle via the attachment means.

12. The grooming tool assembly of claim 11, wherein the second handle-end is substantially open and defines an opening.

13. The grooming tool assembly of claim 12, wherein the second handle-end includes a first handle-thread.

14. The grooming tool assembly of claim 12, wherein the sex toy is configured for insertion into the hidden compartment via the opening of the second handle-end and configured to seal the opening of the second handle-end when the sex toy is housed within the hidden compartment.

15. The grooming tool assembly of claim 14, wherein the second toy-end of the sex toy includes a toy-thread, wherein the toy-thread is configured to mate with the first handle-thread to selectively remove and replace the sex toy within the hidden compartment, and wherein the toy-thread is configured to mate with the first handle-thread to attach the sex toy to the second handle-end and place the sex toy in a ready-for-use position.

16. The grooming tool assembly of claim 11, wherein the attachment means includes the second head-end including a first head-thread, and the first handle-end including a second handle-thread configured to mate with the first head-thread.

17. The grooming tool assembly of claim 11, wherein the at least one grooming tool head includes at least two grooming tool heads, and wherein at least one of the at least two grooming tool heads includes a hairbrush.

18. A grooming tool assembly comprising:
a sex toy; and
a grooming tool, the grooming tool including:
a grooming tool body having:
a handle, the handle including a handle-body having a hidden compartment therein, the hidden compartment configured to discretely house the sex toy, the handle further including a first handle-end and a second handle-end, the second handle-end being substantially open and defining an opening, the second handle-end having a first handle-thread; and
at least one grooming tool head removably connected to the handle via an attachment means, the at least one grooming tool head being selectively detachable from the handle via the attachment means, the at least one grooming tool head including a first head-end and a second head-end; and
wherein the sex toy includes a first toy-end and a second toy-end;
wherein the sex toy is configured for insertion into the hidden compartment via the opening of the second handle-end and configured to seal the opening of the second handle-end when the sex toy is housed within the hidden compartment;
wherein the second toy-end of the sex toy includes a toy-thread;
wherein the toy-thread is configured to mate with the first handle-thread to selectively remove and replace the sex toy within the hidden compartment; and
wherein the toy-thread is configured to mate with the first handle-thread to attach the sex toy to the second handle-end and place the sex toy in a ready-for-use position.

19. The hair grooming tool assembly of claim 18, wherein the attachment means includes the second head-end including a first head-thread, and the first handle-end including a second handle-thread configured to mate with the first head-thread.

20. The hair grooming tool assembly of claim 18, wherein the at least one grooming tool head includes at least two grooming tool heads, and wherein at least one of the at least two grooming tool heads includes a hairbrush.
